(19) United States
(12) Patent Application Publication
(10) Pub. No.: US 2026/0013474 A1
(43) Pub. Date: Jan. 15, 2026

(54) Bidirectionally Activated Leash Release

(71) Applicant: Garnelle D. Tullis, East Orange, NJ (US)

(72) Inventor: Garnelle D. Tullis, East Orange, NJ (US)

(21) Appl. No.: 18/772,556

(22) Filed: Jul. 15, 2024

(51) Int. Cl. A01K 27/00

(52) U.S. Cl. CPC A01K 27/005; A01K 27/003

(57) ABSTRACT

The disclosed bidirectionally activated leash release features a transverse cord and a carabiner clip with a frame hingedly connected to a rotating segment. One end of the cord traverses a bore in the frame and attaches to a crossbar, which is rotatably connected to the carabiner clip, while the other end is fixed to a pull strap. The carabiner opens only when opposing tensional forces are applied to the rotating segment and pull strap. The clip can switch between closed and open configurations, enclosing an interior space in the closed state and allowing release of an animal from the device in the open state. An elongated strap with an embedded cord and a connecting module ensures a contiguous tunnel through aligned bores for reliable operation.

### FIELD OF THE DISCLOSED TECHNOLOGY

The present invention relates to an improved dog leash release mechanism, specifically designed to enhance the ease and convenience of handling animals.

### BACKGROUND

Traditional leashes often feature simple carabiner clips or snap hooks that require considerable manual dexterity and effort to detach the animal. This can be particularly challenging in high-stress situations or emergencies when quick release is crucial. Furthermore, it is often necessary for the handler to kneel down to the level of the animal to operate these mechanisms, which can be especially problematic for users with restricted mobility, such as the elderly or individuals with disabilities.

These conventional leash designs typically lack the reliability or ease of use needed, especially when dealing with strong, large, or fidgety animals that may pull or move unpredictably. The physical strain and difficulty in operating standard clips and hooks not only increase the risk of accidental release but may also pose safety hazards for both the animal and the handler. Additionally, the process can be time-consuming and frustrating, reducing the overall efficiency of managing the animal. For police dogs pursuing criminals, sniffing for drugs, explosives, contraband, and the like, speedy and effortless release from a restraint system is essential.

Additionally, an animal may not always desire to be released from a leash, complicating the use of traditional release mechanisms that allow only the handler to decide when to release the harnessed animal. This unilateral control can create challenges in scenarios where the animal's behavior or needs may indicate a necessity for release, such as in moments of distress, fear, or excitement. Traditional mechanisms often fail to account for the animal's instinctual responses, relying solely on the handler's ability to manage the release process. This can be particularly problematic for handlers who may be distracted, physically restricted, or unable to react swiftly.

Thus, there is a need in the prior art to incorporate the animal's input in the leash release process. There is a further need in the art to enhance the safety and well-being of the animal by providing a mechanism for a canine to escape potentially harmful situations with greater autonomy.

### SUMMARY

An object of the disclosed technology is to allow an animal, such as a canine, to selectively pull taut a leash to, in part, selectively disconnect from the leash. A further object of the disclosed technology is to allow a handler of the animal, such as a canine, to release the animal while remaining standing upright and/or holding the leash taut. A further object of the invention is to allow release of an animal from a leash in the quickest manner and without requiring additional hardware on a dog beyond a collar.

A bidirectionally activated leash release of embodiments of the disclosed technology has a carabiner clip with a frame hingedly connected to a rotating segment. A transverse cord has a first end that traverses a bore through the frame and extends to a crossbar, which is rotatably connected to the carabiner clip. The second end of the cord is fixedly connected to a pull strap. The carabiner clip rotates about an axis of rotation located substantially at the bore.

In some embodiments, a first tensional force exerted upon the rotating segment of the carabiner clip only opens the clip when a second tensional force is exerted on the pull strap, pulling the transverse cord and crossbar away from the rotating segment. These forces may be substantially directionally opposite to one another, i.e directional vectors thereof are substantially colinear.

The carabiner clip, in some embodiments, is repeatedly and selectively switchable between a closed configuration and an open configuration, “repeatedly” being defined as “at least 100 times without loss of functionality”. In the closed configuration, an end of the rotating segment—the end distal to the point of hinged connection to the frame—abuts the frame at a contact point and is secured in place by the crossbar. In the open configuration, the rotating segment is extended away from the contact point. In some embodiments, the rotating segment is extended away from both the contact point and the carabiner clip frame. In some embodiments, in the open configuration, the frame and the rotating segment substantially or fully circumscribe and enclose at least two dimensions of an interior space, while in the open configuration, less than 90% or less than 80% of the interior space enclosed in the closed configuration is circumscribed and closed. In the “open configuration” there is sufficient space for a connector to a leash used to exit from the carabiner.

In some embodiments, the crossbar is hingedly connected to the frame at a point distal to the rotating segment and, if previously opened, resiliently reassumes its default orientation upon cessation of the second tensional force. A “hinged connection” is defined as “a type of joint or fastening that allows two parts to rotate relative to each other around a fixed axis.” Such a connection can be a mechanical linkage between two objects or parts allowing rotational movement around a single axis, such as with a pin or rod passing through aligned cylinders or loops. In some embodiments, the transverse cord is fixedly connected to the crossbar. In other embodiments the transverse cord traverses a bore through the crossbar and terminates at a stopper.

Further embodiments have an elongated strap having a portion of the transverse cord embedded within, “embedded” defined as “being substantially enclosed within another structure”. A connecting module fixedly connected to the strap may have a bore aligned with the carabiner clip bore, through which the transverse cord passes. The connecting module typically is a unitary structure with a hollowed center. The elongated strap, in some embodiments, passes through the hollowed center and is looped around and functionally connected to a segment of the connecting module. The transverse cord may span the hollowed center, which is located between the elongated strap and the carabiner clip. The bore of the connecting module and the bore of the carabiner clip may be located at respective midpoints of respective widths of the connecting module and the frame respectively. The two bores may form a contiguous tunnel traversed by the transverse cord. The carabiner frame may be rotatably connected to the connecting module, rotation occurring about the midpoint of the connecting module. During rotation, the contiguous tunnel is maintained. For purposes of this disclosure, a tunnel is defined as being “contiguous” if the tunnel is traversable by a transverse cord from a first end entry point to a second end exit point, wherein the length of the tunnel constituting gaps is less than 10% of the length of the totality of the tunnel. A “gap” is defined as any material discontinuity which exposes an area, of which a majority is enclosed from surroundings, to the surroundings.

Described another way, a dog release leash of an embodiment of the disclosed technology has an outwardly opening carabiner that circumscribes an interior space in a closed configuration, a portal extending through the base of the carabiner, and a wire extending through the portal and exiting at two spaced-apart locations. The wire has a first end with a handle and a second end with a stopper, the stopper being within the interior space. In some embodiments, the dog release leash further comprises an elongated strap with an internal tunnel, wherein at least part of the wire extends through the internal tunnel. The “internal tunnel” of the elongated strap is defined as “an elongated, substantially enclosed hollow extending within the elongated leash, the hollow being traversable by a cord from an entry point to an exit point.”

Additional embodiments include a crossbar rotatably connected to the carabiner and a nose of the carabiner that is lockable beneath the crossbar. The frame of the carabiner remains substantially or fully in the closed configuration when only one of the ends with the handle or the stopper is pulled. However, in some embodiments, a part of the carabiner frame opens when the handle and an attached chain are simultaneously pulled away from the carabiner, causing the gate to rotate away from the base upon opening.

A method of using the dog leash release involves securing a collar or harness to an animal, opening the carabiner, inserting a portion of the collar or harness into the interior space, and closing the carabiner around the portion of the collar or harness, functionally connecting the collar or harness to the carabiner.

A “functional connection” is defined as “an adjoining or interlocking of a plurality of discrete structures resulting in a specific movement of one of the structures leading to a desired movement of another structure, the movements being integral to the functionality of a larger apparatus.” In the case of the functional connection of the collar or harness to the carabiner, moving the carabiner causes the functionally connected collar or harness to move along with the carabiner.

Further steps of use may include pulling the elongated strap away from the animal when the animal, such as a canine, tensions the strap by moving away from the handle, thus further tensioning the strap, and releasing the animal from the dog leash release.

Described differently, a method of use of the bidirectionally activated leash release comprises steps of securing the collar or harness to the animal, opening the carabiner clip, inserting a portion into the interior space, and closing the rotating segment around it. Additional steps include pulling the pull strap away from the animal when the animal tensions the elongated strap by moving away from the pull strap, thereby releasing the animal from the bidirectionally activated leash release.

While the disclosed technology is referred to as a “dog leash release” or alternatively a “bidirectionally activated leash release,” these terms should be viewed as descriptive of common embodiments of the disclosed technology rather than restrictive of the disclosed technology to use exclusively pertaining to leashes and dogs. The disclosed technology may be used for many animal beyond simply a dog, “animal” defined as an organism belonging to the kingdom Animalia. Thus, for purposes of this disclosure, a human is considered an animal.

Further applications of the disclosed technology may pertain to hoisting systems, wherein in order to release goods suspended in the air by rope from the carabiner, a user of the disclosed technology must open the carabiner clip by pulling the transverse cord, thereby dropping the goods to the ground.

### BRIEF DESCRIPTION OF THE DRAWINGS

FIG. 1 is a front perspective view of a bidirectionally activated leash release in an embodiment of the disclosed technology.

FIG. 2 is a bottom plan view of a connecting module and a carabiner clip of FIG. 1.

FIG. 3 is a front elevation view of a carabiner clip of the bidirectionally activated leash release of FIG. 1 being opened in an embodiment of the disclosed technology.

FIG. 4 is a front elevation view of a carabiner clip of the bidirectionally activated leash release of FIG. 1 being closed in an embodiment of the disclosed technology.

FIG. 5 is a partial front and left side perspective view of the bidirectionally activated leash release of FIG. 1. secured to the wrist of a user.

FIG. 6 is a partial front and left side perspective view of a user tensioning a pull strap of a bidirectionally activated leash release of FIG. 1.

FIG. 7a is a front and left side perspective view of a human handler holding the bidirectionally activated leash release of FIG. 1 restraining a dog in an embodiment of the disclosed technology.

FIG. 7b is a front and left side perspective view of a dog pulling taut the bidirectionally activated leash release of FIG. 1 held by a human handler.

FIG. 7c is a front and left side perspective view of a dog pulling taut the bidirectionally activated leash release of FIG. 1 and a human handler pulling a pull strap to release the dog in an embodiment of the disclosed technology.

FIG. 7d is a front and left side perspective view of a dog released from a bidirectionally activated leash release of FIG. 1 held by a human handler.

### DETAILED DESCRIPTION OF THE DISCLOSED TECHNOLOGY

The disclosed technology aims to provide a novel solution for animal handlers, particularly canine handlers, to facilitate the selective release of an animal from a leash. An objective of this technology is to allow an animal to pull the leash taut, thereby disconnecting itself, or enable the handler to release the animal while maintaining an upright stance and keeping the leash taut. This invention ensures a quick release mechanism without requiring additional hardware on the animal beyond a collar.

Embodiments of the disclosed technology will become more clear in view of the following description of the figures.

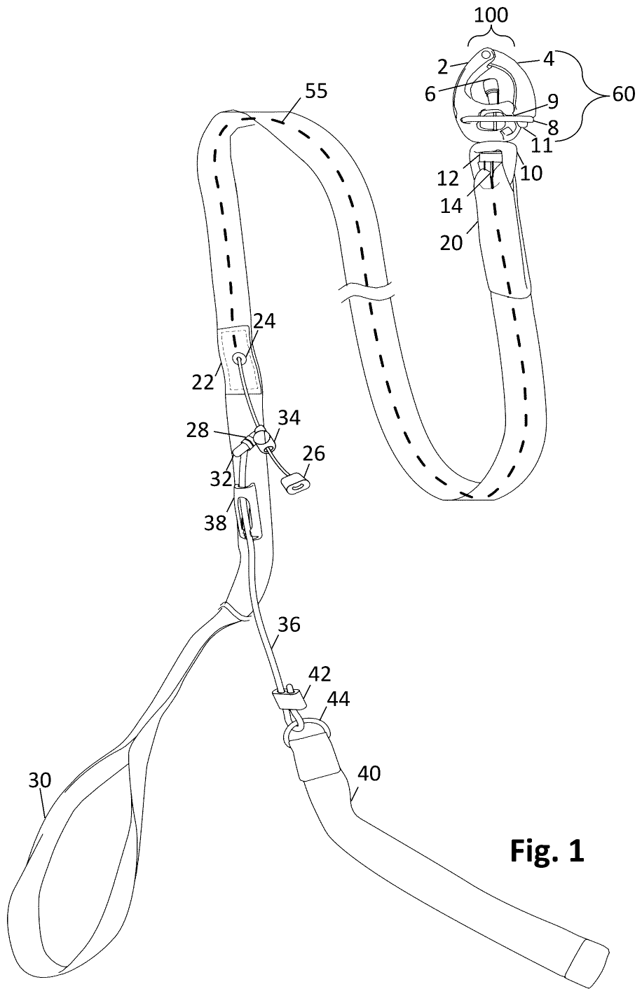

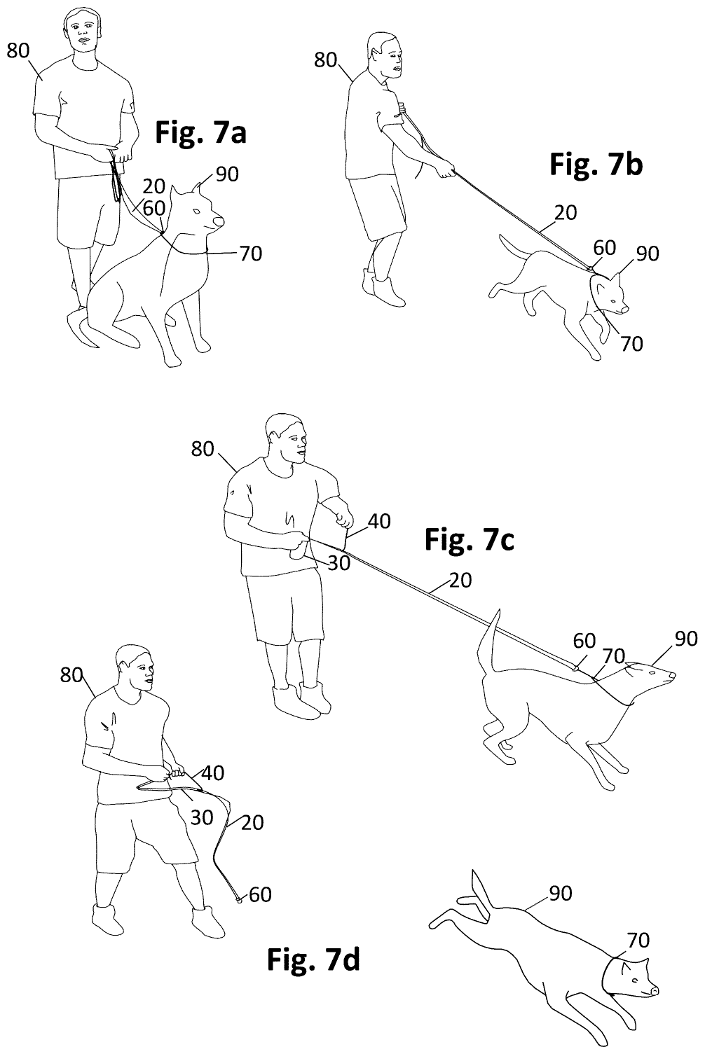

Skipping first to FIG. 7a, FIG. 7a is a front and left side perspective view of a human handler holding the bidirectionally activated leash release of FIG. 1 restraining a dog in an embodiment of the disclosed technology. The human handler 80 holds leash 20, leash 20 having a functional head 60 (to be discussed in more detail below, with reference to FIG. 1) connected to a collar 70 of a canine 90. The canine 70 is restrained by the human handler 80. In this particular depiction, the leash 20 is flaccid. Note that for purposes of this disclosure, a “handler” is synonymous with a “user” of the disclosed technology, specifically the user who engages the pull strap to release a restrained animal.

FIG. 7b is a front and left side perspective view of a dog pulling taut the bidirectionally activated leash release of FIG. 1 held by a human handler. The leash 20 is connected to a collar 70 of the dog 90 via the functional head 60. The dog 90 is pulling taut the leash by way of the collar 70. It should be understood that embodiments of the disclosed technology function when the leash is taut regardless of what is generating the forces required to hold the leash 20 taut against the collar 70. The tension generated from the pulling of the dog constitutes a first tensional force which straightens and outstretches the leash 20.

FIG. 7c is a front and left side perspective view of a dog pulling taut the bidirectionally activated leash release of FIG. 1 and a human handler pulling a pull strap to release the dog in an embodiment of the disclosed technology. The handler 80 applies a tensional force, this tensional force constituting a second tensional force, acting on the pull strap 40. The handler 80 simultaneously maintains hold of the leash 20 by clasping a hand around hand hold 30. The two tensional forces acting on the leash 20 with connection point 60 release the leash 20 from the dog collar 70, thus freeing the dog 90 to move about unrestrictedly.

The dog 90 free from the leash 20 is shown in FIG. 7d. Mechanisms with which the tensional forces release the dog 90 from the leash 20 will become clear with further discussion of the drawings.

FIG. 1 is a front perspective view of a bidirectionally activated leash release in an embodiment of the disclosed technology. Functional head 60 comprises a carabiner clip 100 having a frame 2 and a rotating segment 4, hingedly connected to one another at a point 5 (see also FIG. 3). In a closed configuration, as depicted in FIG. 1, an end 11 of the rotating segment 4, the end 11 distal to a point of hinged connection 5 to the frame 2, abuts the frame 2 at a contact point 9 and is rigidly positionally secured by a crossbar 8; the crossbar 8 is hingedly connected to the frame 2. In the closed configuration, the frame 2 and the rotating segment 4 substantially circumscribe and enclose at least two dimensions of an interior space. In many embodiments of the disclosed technology, the interior space is prismatic and has two ovoid bases, the bases being unbounded by the carabiner clip 100. The carabiner clip, namely the frame 2 and the rotating segment 4, substantially circumscribe the length and the width of the interior space, where the height of the prism is defined as the dimension between the two bases.

A connecting module 10 is rotatably connected to the carabiner clip 100, such that the one of the connecting module 10 and the carabiner clip 100 may be rotated 360 degrees whilst the other is stationary, and vice versa. Furthermore, both may be rotated simultaneously relative to one another in opposite directions of rotation.

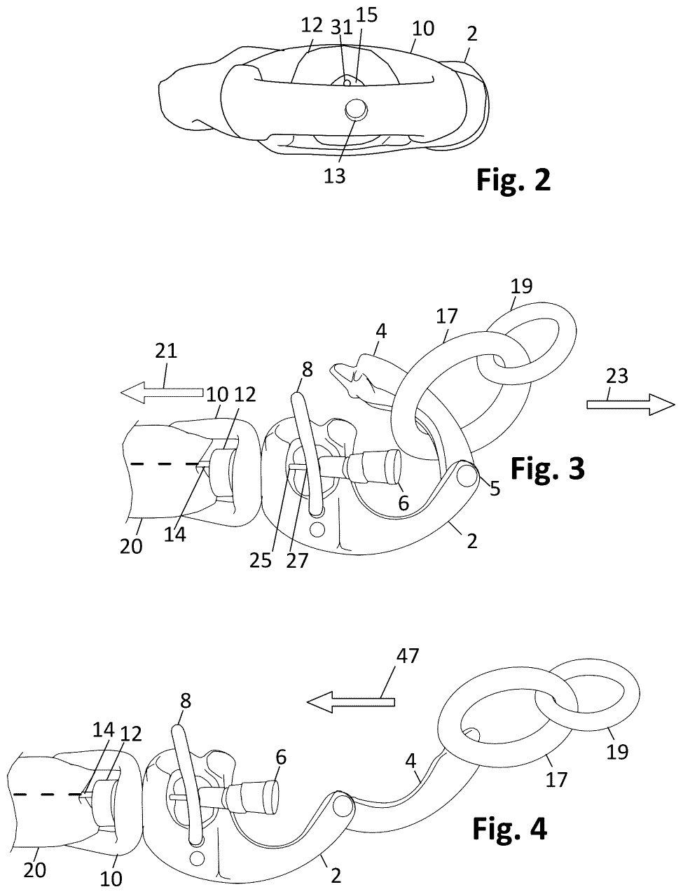

Turning now to FIG. 2, FIG. 2 shows a bottom plan view of a connecting module and a carabiner clip of FIG. 1. As shown in this figure, a bore 13 is disposed substantially at, or at, a lateral and/or longitudinal midpoint of the width of the connecting module 10, the bore being located at a side of the connecting module 10 distal to (defined as, “at a side furthest from”) the carabiner clip 100 and being substantially collinear with a bore 15 in a disc 12. Bore 15 aligns with a further bore 31 located substantially at a lateral and/or longitudinal midpoint of a side of the connecting module 10 that is proximal to the frame 2. The “lateral” and “longitudinal” lengths are perpendicular to each other and pass through the bore 15 perpendicular to the longest length thereof, and are respectively, at a narrowest and a widest cross-section of the connecting module 10. In a different definition which may coincide with the prior definition, “lateral” is defined as “from side to side, forming a linear length parallel to a longest linear length between opposite sides of the elongated strap 20, the longest linear length being parallel to the ground, while the bidirectionally activated leash device is suspended above the ground from point 5 only.” “Longitudinal”, which, again, may coincide with the prior definition, may instead be defined as “from top to bottom, forming a linear length perpendicular to the ground while the bidirectionally activated leash device is suspended above the ground from point 5 only.” The bore 13 is centered about a rotational axis of the connecting module 10 in order that the functionality of the device is retained, and tangling/rotation of the leash is prevented during usage.

Turning to FIG. 3 in conjunction with FIG. 2, FIG. 3 is a front elevation view of a carabiner clip of the bidirectionally activated leash release of FIG. 1 being opened in an embodiment of the disclosed technology. Frame 2 has a bore 25 disposed substantially at a lateral midpoint of a side located proximally to the connecting module 10. The two bores 31 and 25 form a substantially contiguous tunnel, the substantial continuity of which is resiliently maintained during a rotation of either one of or both the connecting module 10 or the carabiner clip 100, “resiliently” defined as “designed to maintain structural and functional integrity and shape during repeated (>100 iterations) use of the device claimed”. Crossbar 8 further is traversed longitudinally by a bore 27 collinear with the aforementioned bores. Turning back to FIG. 1, the axis of rotation of the connecting module 10 and the carabiner clip 100 when either one of the two rotates is defined by an axis connecting the aforementioned bores.

The aforementioned bores are traversed by a transverse cord 14 terminating at a stopper 6 within the interior space circumscribed by the carabiner clip 100 in the closed configuration. The transverse cord is thus substantially or exactly longitudinally extending through the axis of rotation. The disc 12 serves to positionally secure the transverse 14 cord, aligning the transverse cord 14 with the aforementioned bores. The disc 12 may be rotatably or fixedly connected to the connecting module. The transverse cord 14 further extends through and traverses an internal tunnel 55 of an elongated strap 20. As shown in FIG. 1 and subsequent drawings, the elongated strap 20 extends and loops through a portal within the connecting module 10 before terminating at an end abutted against an intermediate point of the elongated strap 20, thus functionally connecting the elongated strap 20 to the connecting module 10. A first end of the internal tunnel 55 of the elongated strap 20 collinearally aligns with bore 13 (see FIG. 2). The transverse cord 14 exits the internal tunnel 55 at a second end 24 of the internal tunnel 55, disposed at a region 22 of the elongated strap, before extending through a bore in a coil interface mechanism 34 and to a second stopper 26. The coil interface mechanism 34 may, in some embodiments, be fixedly connectable to the transverse cord 14 at a plurality of points along the transverse cord 14; “fixedly connectable” is defined as “being able to repeatedly attach and detach two separate structures immovably to each other.”

The coil interface mechanism 34 is thus named, as a secondary cord 36 is fixedly and functionally connected to the coil interface mechanism 34 at a terminating coil 28, the terminating coil wrapped helically about an oblong ellipsoid flange 32. The secondary cord 36 is positionally secured with respect to the elongated leash 20 by fastener 38; fastener 38 is fixedly connected to the elongated leash 20 and has portal through which the secondary cord 36, in some configurations, passes before looping through link 44 and terminating at a stopper 42. Link 44 is thus functionally connected to the secondary cord 36, while also being functionally connected to a pull strap 40. A chain of functional connection is thereby established whereby pull strap 40 effectuates, in part, the configuration assumed by functional head 60, as will be further described in view of subsequent drawings. The elongated leash 20 terminates with a wrist loop 30 which can be wrapped around the hand or wrist of a human user of the disclosed technology.

Still referring to FIG. 3, the carabiner clip 100 is opened when two tensional forces act upon the bidirectionally activated leash release, the two tensional forces being, in some embodiments, substantially directionally opposite one another. The first tensional force 23 is exerted upon the rotating segment 4 by, in some embodiments, an animal pulling on leash 20 (as shown in FIG. 7b). The transference of the first tensional force 23 from the animal to the rotating segment 4 may occur via connecting loops 17 and 19, connecting loop 19 functionally connecting the harness 70 of the animal 90 to connecting loop 17, which is functionally connected to rotating segment 4. Described differently, the animal 90, the harness 70, the connecting loops 17 and 19, and rotating segment 4 constitute a chain comprising interconnected links, such that pulling a link at the end of the chain exerts tension on all previous links. The second tensional force 21 is exerted upon the pull strap 40, pulling the transverse cord 14 which in turn pulls the stopper 6, the stopper abutting and pushing the crossbar 8 away from the rotating segment 4 and contact point 9 (as shown in FIG. 1) and towards the connecting module 10. After a cessation of the first and second tensional forces 23 and 21, the crossbar 8, in embodiments of the disclosed technology, resiliently reassumes a default configuration wherein an end thereof abuts rotating segment 4 and frame 2 at the contact point 9.

While the carabiner 100 is in a closed configuration (refer back to FIG. 1), the crossbar 8 positionally secures the rotating segment 4 in place with respect to the frame 2 by physically impeding the path of motion of the rotating segment 4. Thus, the first tensional force 23 must, in order to open the carabiner 100, be paired with the second tensional force 21 to remove the obstruction of crossbar 8. In open configuration, wherein the end of rotating segment 4 distal to hinged connection point 5 is moved away from the contact point 9 and the frame 2, the rotating segment 4 and the frame 2 circumscribe and enclose said less than 90% of the two dimensions of the interior space circumscribed in the closed configuration.

FIG. 4 is a front elevation view of a carabiner clip of the bidirectionally activated leash release of FIG. 1 being closed in an embodiment of the disclosed technology. Arrow 47 indicates the direction of motion of the rotating segment 4 towards the contact point 9 upon the cessation of the first tensional force 23. After a cessation of the first and second tensional forces 23 and 21, the crossbar 8, in embodiments of the disclosed technology, resiliently reassumes a default configuration wherein an end thereof abuts rotating segment 4 and frame 2 at the contact point 9. In order for the crossbar 8 to block the carabiner 100 from opening due to an application of only the first tensional force 23, the first tensional force must, in some embodiments, cease before the second tensional force ceases during closure of the carabiner, thereby allowing the rotating segment 4 to abut the contact point 9 before being secured in place by the crossbar 8. Should the crossbar 8 abut the contact point 9 before the rotating segment 4 does so, the crossbar, in some embodiments, may block the carabiner 100 from fully closing.

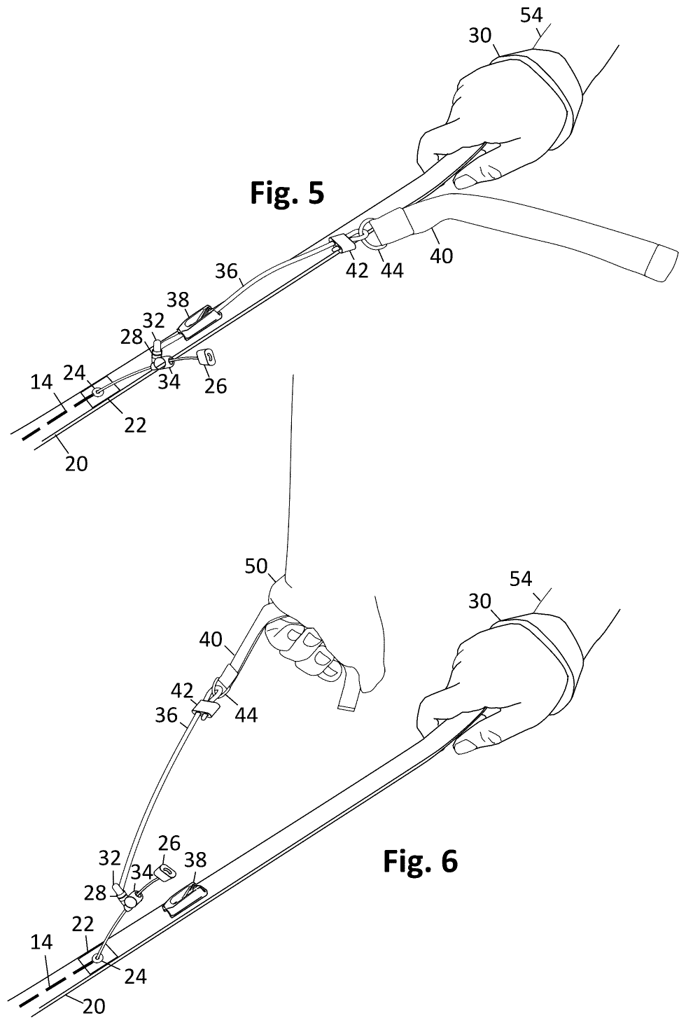

FIG. 5 is a partial front and left side perspective view of the bidirectionally activated leash release of FIG. 1. secured to the wrist 54 of a user by hand hold 30. The pull strap 40 lies out of the grasp of the user, indicating that the second tensional force 21 is yet to be applied.

FIG. 6 is a partial front and left side perspective view of a user tensioning the pull strap 40 of a bidirectionally activated leash release of FIG. 1 with hand 50. The hand 50 pulls the pull strap 40, which pulls the secondary cord 36, which pulls the transverse cord 14, which pulls the stopper 6, pushing the crossbar 8 towards the connecting module 10, as previously described with reference to FIG. 3. In this condition, the first tensional force 23 applied to the rotating segment 4 can open the carabiner 100. The secondary cord 36 is, in embodiments such as that shown in FIG. 6, released from fastener 38 whilst pulled and tensioned.

Any device or step to a method described in this disclosure can comprise or consist of that which it is a part of, or the parts which make up the device or step. The term “and/or” is inclusive of the items which it joins linguistically and each item by itself.

For the purpose of this disclosure, the term “Substantially” is defined as “at least 95% of” the term being described” which it modifies, i.e. within the range of 95% to 100% of the term being modified, inclusive.

Any device or aspect of a device or method described herein can be read as “comprising” or “consisting” thereof.

When the term “or” is used, it creates a group which has within either term being connected by the conjunction as well as both terms being connected by the conjunction.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within understood that the phraseology or the terminology employed herein is for description and not of limitation. Therefore, while the embodiments herein have been described in terms of preferred embodiments, those skilled in the art will recognize that the embodiments herein can be practiced with modification within the spirit and scope of the appended claims.

I claim:

1. A bidirectionally activated leash release comprising:
a carabiner clip having a frame hingedly connected to a rotating segment; and
a transverse cord having a first end traversing a bore through said frame and extending, at least, to a crossbar, said crossbar rotatably connected to said carabiner clip, and a second end of said cord fixedly connected to a pull strap;
wherein said carabiner clip rotates about an axis of rotation located substantially at said bore.

2. The bidirectionally activated leash release of claim 1, wherein
a first tensional force exerted upon said rotating segment of said carabiner clip only opens said carabiner clip when a second tensional force is exerted on said pull strap, said second tensional force pulling said transverse cord and said crossbar away from said rotating segment.

3. The bidirectionally activated leash release of claim 2,
wherein said first tensional force and said second tensional force are substantially directionally opposite to one another.

4. The bidirectionally activated leash release of claim 3, wherein said carabiner clip is repeatedly and selectively switchable between:
a closed configuration, wherein an end of said rotating segment distal to a point of hinged connection to said frame abuts said frame at a contact point and is rigidly positionally secured by said crossbar, and said frame and said rotating segment substantially circumscribe and enclose at least two dimensions of an interior space; and
an open configuration, wherein said end of said rotating segment is moved away from said contact point, and said frame and said rotating segment circumscribe and enclose said less than 90% of said two dimensions of said interior space circumscribed in said closed configuration.

5. The bidirectionally activated leash release of claim 4, wherein
said crossbar is hingedly connected to said frame at a point distal to said rotating segment; and
said crossbar resiliently reassumes a default orientation, upon a cessation of said second tensional force, whilst open.

6. The bidirectionally activated leash release of claim 5, wherein,
in said open configuration, said end of said rotating segment extends away from said frame.

7. The bidirectionally activated leash release of claim 4, further comprising:
an elongated strap, a portion of said transverse cord embedded therein; and
a connecting module fixedly connected to said elongated strap and having a bore substantially aligned with said bore of said carabiner clip frame;
wherein at least one segment of a longest dimension of said transverse cord is embedded within said elongated strap and traverses both said bores.

8. The bidirectionally activated leash release of claim 7, wherein
said bore of said carabiner frame is located substantially at a midpoint of a width of said frame;
said bore of said connecting module is located substantially at a midpoint of a width of said connecting module;
said carabiner frame is rotatably connected to said connecting module, such that said carabiner frame is resiliently rotatable substantially about said midpoint thereof; and
during said rotation, a substantially contiguous tunnel comprised of both said bores is maintained.

9. The bidirectionally activated leash release of claim 1, wherein
said transverse cord is fixedly connected to said crossbar.

10. The bidirectionally activated leash release of claim 1, wherein
said transverse cord traverses a bore through said crossbar and terminates at a stopper.

11. A dog release leash, comprising:
an outwardly opening carabiner circumscribing an interior space in a closed configuration;
a portal extending through a base of said carabiner; and
a wire extending through said portal and exiting therefrom at two spaced apart locations, said wire having a first end with handle and a second end with stopper, said stopper being within said interior space.

12. The dog release leash of claim 11, further comprising an elongated strap with internal tunnel, wherein at least a part of said wire extends through said internal tunnel.

13. The dog release leash of claim 12, further comprising:
a crossbar rotatably connected to said carabiner; and
a nose of said carabiner lockable beneath said crossbar.

14. The dog release leash of claim 13, wherein said frame of said carabiner remains substantially or fully in said closed configuration when only one of said first end with handle or said second end with stopper is pulled.

15. The dog release leash of claim 13, wherein a part of a frame of said carabiner opens upon a combination of said handle of said wire, and said chain attached to said carabiner, being simultaneously pulled away from said carabiner.

16. The dog release leash of claim 15, wherein
said gate is rotated away from said base upon an opening of said carabiner.

17. A method of using the dog leash release of claim 16, comprising steps of, in any order:
securing a collar or harness to an animal;
opening said carabiner;
inserting a portion of said collar or said harness into said interior space;
closing said carabiner around said portion of said collar or harness, functionally connecting said portion to said carabiner.

18. Instructing or executing the instructions of claim 17, further comprising steps of:
pulling said elongated strap away from said animal, when said animal tensions said elongated strap by moving away from said handle, further tensioning said elongated strap; and
releasing said animal or human from said dog leash release.

19. The method of using the bidirectionally activated leash release of claim 8, comprising steps of:
securing a collar or harness to an animal;
opening said carabiner clip;
inserting a portion of said collar or said harness into said interior space;
closing said rotating segment around said portion of said collar or harness, functionally connecting said portion to said carabiner clip.

20. The method of claim 19, further comprising steps of:
pulling said pull strap away from said animal, when said animal tensions said elongated strap by moving away from said pull strap, further tensioning said elongated strap; and
releasing said animal from said dog leash release.
